(19) United States
(12) Patent Application Publication
(10) Pub. No.: US 2015/0099081 A1
(43) Pub. Date: Apr. 9, 2015

(54) COMPOSITE SYSTEM FOR ENCAPSULATING ELECTRONIC ARRANGEMENTS

(71) Applicant: tesa SE, Hamburg (DE)

(72) Inventors: Minyoung Bai, Hamburg (DE); Thilo Dollase, Hamburg (DE); Jan Ellinger, Hamburg (DE); Judith Grünauer, Hamburg (DE)

(21) Appl. No.: 14/382,130

(22) PCT Filed: Feb. 7, 2013
(86) PCT No.: PCT/EP2013/052422

§ 371 Date: Aug. 29, 2014

(30) Foreign Application Priority Data
Mar. 7, 2012 (DE) 10 2012 203 623.7

(51) Int. Cl. C09J 7/02; B32B 38/10; B32B 37/12; C09J 5/00

(52) U.S. Cl. CPC C09J 7/0232; C09J 7/0207; C09J 5/00; B32B 38/10; B32B 37/12
USPC 428/41.1; 427/355; 156/249; 428/41.8; 428/41.3

(57) ABSTRACT

An adhesive strip, with improved barrier effect, encapsulates electronic arrangements against permeates, whereby the composite system comprises at least (a) an adhesive strip containing at least one pressure-sensitive adhesive substance for direct application on a substrate; and (b) at least one release liner which lies directly upon the pressure-sensitive adhesive substance, wherein the surface of the release liner, that faces the pressure-sensitive adhesive substance, has a surface roughness of less that 100 nm, measured as an arithmetic mean Sa as per ISO/FDIS 25178-2:2011 of the amounts of at least 10,000 height values of the profile of a partial surface of at least 200 μm×200 μm. A method produces a release liner with a smooth surface for equipping barrier adhesive strips by removing the liner in order to encapsulate electronic arrangements with the adhesive strip.

The present invention relates to the technical field of adhesive tapes. In particular, the invention proposes combining an adhesive tape and a release liner with specific surface character, thus permitting achievement of an improved barrier effect in relation to substances potentially permeating the adhesive tape.

An ever-increasing number of optoelectronic arrangements are used in commercial products or are about to be introduced into the market. These arrangements comprise inorganic or organic electronic structures, for example organic, organometallic, or polymeric semiconductors, or else combinations thereof. The products here are designed to be rigid or flexible as required by the desired application, but there is an increasing demand here for flexible arrangements. These arrangements are often produced via printing processes, for example relief printing, intaglio printing, screen printing, flatbed printing, or else what is known as non-impact printing, for example thermal transfer printing, inkjet printing, or digital printing. However, vacuum processes are also often used, examples being chemical vapor deposition (CVD), physical vapor deposition (PVD), plasma-assisted chemical or physical deposition processes (PECVD), sputtering, (plasma) etching, or other vapor deposition processes. Structuring is generally achieved via masks.

Examples that may be mentioned here of optoelectronic applications that are already obtainable commercially or that are of interest for their potential marketability are electrophoretic or electrochromic structures or displays, organic or polymeric light-emitting diodes (OLEDs or PLEDs) in readout and display devices or in the form of illumination, and also electroluminescent lamps, light-emitting electrochemical cells (LEECs), organic solar cells, for example dye- or polymer-based solar cells, inorganic solar cells, in particular thin-layer solar cells, based for example on silicon, germanium, copper, indium, and selenium, organic field-effect transistors, organic switching elements, organic optical amplifiers, organic laser diodes, organic or inorganic sensors, and also RFID transponders based on organic or inorganic systems.

A technical challenge in achieving adequate lifetime and function of optoelectronic arrangements in the field of inorganic and organic optoelectronics, very particularly organic optoelectronics, is to protect the components comprised therein from permeates. The term permeates is generally used here for gaseous or liquid substances which can penetrate into a solid and can sometimes permeate through, or migrate through, said solid. Accordingly, many low-molecular-weight organic or inorganic compounds can be permeates, but in the context described here particular importance is attached to water vapor and oxygen.

Many optoelectronic arrangements—particularly those using organic materials—can be damaged by water vapor and also by oxygen. Encapsulation is therefore necessary to protect the electronic arrangements throughout their lifetime, since otherwise performance deteriorates over the period of usage. By way of example, oxidation of constituents can cause rapid drastic reduction of the light emitted by light-emitting arrangements such as electroluminescent lamps (EL lamps) or organic light-emitting diodes (OLEDs), of contrast in the case of electrophoretic displays (EP displays), or of efficiency in the case of solar cells.

In the field of inorganic and in particular organic optoelectronics, there is therefore a major requirement for flexible adhesive solutions which provide a barrier to permeates such as oxygen and/or water vapor. These adhesive systems are moreover intended not only to bring about good adhesion between two substrates but also to comply with other requirements such as high shear strength and peel strength, chemical stability, aging resistance, high transparency, good processability, and also high flexibility and pliability.

An approach commonly used in the prior art is therefore to place the electronic arrangement between two substrates impermeable to water vapor and oxygen. The edges are then sealed. Glass or metal substrates are used for inflexible structures and provide a high permeation barrier, but are very easily damaged by mechanical loads. These substrates moreover give the entire arrangement a relatively high thickness. In the case of metal substrates there is also no transparency. Substrates that can be used for flexible arrangements are, in contrast, transparent or non-transparent foils, which may be of multilayer design. It is possible here to use combinations of various polymers, or else to use inorganic or organic layers. Use of substrates of this type can give a flexible, extremely thin structure. A very wide variety of substrates can be used for the various applications, examples being foils, textiles, nonwovens, and papers, or a combination thereof.

In order to achieve the best possible sealing, specific barrier adhesives are used. A good adhesive for the sealing of (opto)electronic components has low permeability to oxygen and in particular to water vapor, has adequate adhesion on the arrangement, and can achieve good flow onto said arrangement. Low adhesion on the arrangement reduces the barrier effect at the interface, thus permitting ingress of oxygen and water vapor, irrespective of the properties of the adhesive. The properties of the adhesive are the determining factor for the barrier effect provided by the adhesive only when there is continuous contact between adhesive and substrate.

It is vital that the adhesive layers provide a good barrier effect in the application. A distinction is made here between volume permeation and interface permeation. Volume permeation can be controlled via the composition of the adhesive. Interface permeation is also dependent on the ability of the adhesive layer to flow onto the adhesive substrate. The barrier effect is usually characterized by stating the oxygen transmission rate (OTR) and the water vapor transmission rate (WVTR). The respective rate here is the flow rate of oxygen and, respectively, water vapor through a film under specific conditions of temperature and partial pressure and also, where appropriate, other measurement conditions such as relative humidity, per unit of area and of time. The smaller these values, the better the suitability of the respective material for encapsulation.

Interface permeation can be determined via a combination of various water vapor permeability measurements (WVTR). What is known as a MOCON test provides the volume water vapor barrier of a material WVTR (MOCON). What is known as a calcium test, WVTR (Ca test), provides water vapor permeation through volume and interface. The permeation data here are not simply the WVTR or OTR values, but always also include an average permeation path length, e.g. the thickness of the material, or standardization to a particular path length. Volume permeation for a given adhesive is always identical under identical measurement conditions. Changes in the WVTR (Ca test) can then be attributed to differences in interface permeation.

Permeability P is a measure of the ability of a body to permit passage of gases and/or liquids. A low P value indicates a good barrier effect. Permeability P is a specific value for a defined material and a defined permeate under steady-state conditions for a particular permeation path length, partial pressure, and temperature. Permeability P is the product of diffusion term D and solubility term S: P=D*S.

The solubility term S describes the affinity of the barrier adhesive for the permeate. In the case of water vapor by way of example, hydrophobic materials achieve a low value for S. The diffusion term D is a measure of the mobility of the permeate in the barrier material and depends directly on properties such as molecular mobility or free volume. In the case of highly crosslinked or highly crystalline materials, relatively low values are often achieved for D. However, highly crystalline materials are generally less transparent, and more crosslinking leads to less flexibility. Permeability P usually rises as molecular mobility increases, and this is also true when, for example, temperature is increased or the glass transition temperature is exceeded.

Attempts to increase the barrier effect of an adhesive must give particular attention to the two parameters D and S in respect of their influence on permeability to water vapor and oxygen. Other effects that also require consideration, in addition to these chemical properties, are physical influences on permeability, in particular average permeation path length and interface properties (flow behavior of the adhesive during application, adhesion). The ideal barrier adhesive has low D values and S values with very good adhesion on the substrate.

A low solubility term S is not usually sufficient to achieve good barrier properties. Siloxane elastomers in particular are a typical example here. These materials are extremely hydrophobic (small solubility term) but, by virtue of their freely rotatable Si—O bond (large diffusion term), have comparatively little barrier effect in relation to water vapor and oxygen. A good barrier effect therefore requires a good balance between solubility term S and diffusion term D.

Materials used hitherto for this purpose have been primarily liquid adhesives and epoxy-based adhesives (WO 98/21287 A1; U.S. Pat. No. 4,051,195 A; U.S. Pat. No. 4,552,604 A). A high level of crosslinking gives these a low diffusion term D. Their main field of application is adhesive bonding of edges of rigid arrangements, or else arrangements having moderate flexibility. Hardening is achieved thermally or by means of UV radiation. Full-surface adhesive bonding is difficult because of the shrinkage caused by the hardening process, since stresses arise between adhesive and substrate during the hardening process and can in turn lead to delamination.

Use of these liquid adhesives has many attendant disadvantages: low-molecular-weight constituents (VOCs—volatile organic compounds) can damage the sensitive electronic structures of the arrangement and create difficulties during the production process. A complicated procedure is required to apply the adhesive to each individual constituent of the arrangement. Expensive dispensers and fixing equipment have to be purchased in order to ensure precise positioning. Furthermore, this application method cannot give a rapid continuous process, and the laminating step that is subsequently needed can also make it more difficult, because of the low viscosity, to achieve a defined layer thickness and adhesive bond width within narrow limits.

These highly crosslinked adhesives moreover have low flexibility after the hardening process. At low temperatures, or in the case of 2-component systems, the use of thermally crosslinking systems is restricted by pot life, i.e. the processing time available prior to gelling. At high temperatures, and in particular in the case of long reaction times, the usefulness of these systems is in turn restricted by the delicate (opto)electronic structures—the highest temperatures that can be used with (opto)electronic structures are often 60° C., since incipient damage can begin at a temperature as low as this. Particularly stringent restrictions are imposed here by flexible arrangements which comprise organic electronic systems and have been encapsulated with transparent polymer foils or with composites made of polymer foils and of inorganic layers. This also applies to lamination steps using high pressure. In order to achieve improved durability here, it is advantageous to omit any step that causes thermal stress, and to use relatively low lamination pressure.

Other materials now also widely used as an alternative to thermally curable liquid adhesives are radiation-curing adhesives (US 2004/0225025 A1). Use of radiation-curing adhesives avoids exposure of the electronic arrangement to any long period of thermal stress. However, the irradiation causes brief local heating of the arrangement, since alongside any UV radiation there is generally also a very high proportion of IR radiation emitted. Other abovementioned disadvantages of liquid adhesives are likewise still present, for example VOCs, shrinkage, delamination, and low flexibility. Problems can arise due to additional volatile constituents or cleavage products from the photoinitiators or sensitizers. The arrangement moreover has to be permeable to UV light.

Constituents particularly of organic electronic systems are often susceptible to damage by UV, and this is also often true for many of the polymers used; long periods of external use are therefore not possible without further additional protective measures, for example further covering foils. In the case of UV curing adhesive systems, these foils can be applied only after the UV-curing process, and this additionally increases the complexity of the manufacturing process and the thickness of the arrangement.

US 2006/0100299 A1 discloses a UV-curable pressure-sensitive adhesive tape for the encapsulation of an electronic arrangement. The pressure-sensitive adhesive tape comprises an adhesive based on a combination of a polymer with softening point above 60° C. with a polymerizable epoxy resin with softening point below 30° C. and with a photoinitiator. The polymers can be polyurethane, polyisobutylene, polyacrylonitrile, polyvinylidene chloride, poly(meth)acrylate, or polyester, but in particular an acrylate. Other materials present are adhesive resins, plasticizers, or fillers.

Acrylates have very good resistance to UV radiation and to various chemicals, but have very different adhesion values on various substrates. While adhesion on polar substrates such as glass or metal is very high, adhesion on nonpolar substrates such as polyethylene or polypropylene is rather low. The risk of diffusion at the interface is particularly prevalent here. These adhesives are moreover very polar, and this promotes diffusion in particular of water vapor, despite subsequent crosslinking. Use of polymerizable epoxy resins further increases this tendency.

The pressure-sensitive adhesive embodiment mentioned in US 2006/0100299 A1 has the advantage of easy application, but likewise suffers from possible cleavage products by virtue of the photoinitiators present, and from necessary UV permeability of the structure, and from reduced flexibility after hardening. The crosslinking density achievable is moreover, very much lower than with liquid adhesives, because of the low proportion of epoxy resins or other crosslinking agents that is necessary for tack and in particular cohesion.

Pressure-sensitive adhesive tapes comprise relatively high-molecular-weight polymers and are therefore unlike liquid adhesives in requiring, for good wetting and adhesion on a surface, a certain time, an adequate pressure, and a good balance between viscous component and elastic component. The subsequent crosslinking of the adhesives generally leads to shrinkage of the adhesive. This can lead to reduced adhesion at the interface and can in turn increase permeability.

WO 2007/087281 A1 discloses a transparent flexible pressure-sensitive adhesive tape based on polyisobutylene (PIB) for electronic applications, in particular OLEDs. Materials used here are polyisobutylene with molar mass above 500 000 g/mol and a hydrogenated cyclic resin. It is optionally possible to use a photopolymerizable resin and a photoinitiator.

Adhesives based on polyisobutylene have good barrier properties in relation to water vapor, due to their low polarity, but even at high molecular weights they have relatively low cohesiveness, and therefore even at room temperature and in particular at elevated temperatures it is possible to observe a tendency toward creep under load, and the adhesives therefore have low shear strength. The proportion of low-molecular-weight constituents cannot be reduced as desired, because otherwise adhesion is markedly reduced and interface permeation increases. Use of a high proportion of functional resins is necessary because of the very low cohesion of the adhesive, but this in turn increases the polarity of the adhesive, and thus increases the solubility term.

In contrast to this, a pressure-sensitive adhesive with a high level of crosslinking exhibits good cohesion, but has impaired flow behavior during application. The pressure-sensitive adhesive has inadequate ability to conform to the roughness of a substrate surface, and permeation at the interface is thus increased. A pressure-sensitive adhesive with a high level of crosslinking moreover has only relatively little capability to dissipate the deformation energy that is generated under load. Both phenomena reduce adhesion. In contrast to this, a pressure-sensitive adhesive having a low level of crosslinking can provide very good flow onto rough surfaces during application and can dissipate deformation energy, and can thus provide compliance with adhesion requirements, but the pressure-sensitive adhesive has inadequate resistance to load, because of reduced cohesion.

The prior art moreover discloses a pressure-sensitive adhesive without barrier properties (WO 03/065470 A1) which is used as transfer adhesive in an electronic structure. The adhesive comprises a functional filler which reacts with oxygen or water vapor within the structure. This permits easy application of a scavenger within the structure. Another adhesive with low permeability is used for the external sealing of the structure.

An adhesive based on vinylaromatic block copolymers is moreover disclosed by way of example in U.S. Pat. No. 4,985,499 A1. Said document describes various advantageous compositions of the adhesive.

The prior art moreover discloses the barrier effect of block copolymers (US 2002/0188053 A1). Here, polymers on this basis are used for the sealing of electrophoretic displays, in that once the active substances have been applied they are covered with a solution of the polymer, and the dried solution acts as sealing layer and fixing means. These polymers have no self-adhesive properties, and they achieve adhesion on the other components of the electrophoretic display structure only by virtue of the wetting generated by the solution. This requires the use of solvents, and produces emissions, and involves difficult metering.

Another issue to which consideration is increasingly being given, alongside the design of the adhesives, relates to the liners used to protect the adhesives; these are intended to protect the adhesive, during the period between production and application thereof, from ingress of substances which could be detrimental to the substrates that are to be bonded or to be sealed: EP 2 078 608 A1 discloses that liners can be equipped with a specific permeation barrier made of polymer.

DE 10 2009 046 362 concerns polyolefin-based pressure-sensitive adhesives. Barrier applications are mentioned as examples of these adhesives. WO 2009/086095 concerns barrier adhesive tapes which comprise desiccants in the adhesive. Both documents mention polyester- or polypropylene-based liners.

U.S. Pat. No. 4,454,266 discloses liners with various roughness values of the liner carrier material.

EP 1 518 912 teaches an adhesive which is intended for the encapsulation of an electroluminescent element and which comprises a photocationically curable compound and a photocationic initiator. Paper-based and polyester-based liners are mentioned.

US 2009/026934 describes adhesive layers for the encapsulation of organic electroluminescent elements. The adhesives comprise polyisobutylene and a hydrogenated hydrocarbon resin. A polyester liner is provided as liner in the example.

US 2010/0137530 discloses curable adhesive layers based on epoxy resin mixtures. One type of epoxy resin has low molar mass, and another has higher molar mass. Curing is achieved cationically, with UV initiator. Polymer liners are mentioned.

U.S. Pat. No. 6,153,302 proposes use of a liner that blocks actinic radiation in order to protect continuous webs of UV-sensitive materials from undesired UV irradiation.

There is an ongoing requirement for adhesive systems for the encapsulation of delicate electronic arrangements with a high level of barrier effect in relation to detrimental substances. It is therefore an object of the invention to provide an adhesive system of this type which can eliminate the disadvantages of the prior art and in particular which provides an increased barrier effect in relation to water and oxygen. The system is also intended to have a low equilibrium moisture level, and ideally also to provide protection from the effects of light and of UV.

The concept underlying the achievement of the object is use of a liner with a specific surface structure. The invention therefore firstly provides a composite system for the encapsulation of electronic arrangements which comprises at least
a) an adhesive tape comprising at least one pressure-sensitive adhesive for direct application on a substrate; and
b) a release liner superposed directly on the pressure-sensitive adhesive, where the surface roughness of the release liner surface facing toward the pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 100 nm.

A composite system of this type advantageously provides not only the volume barrier effect determined by the nature and composition of the adhesive but also the interface barrier effect, and thus permits provision of adhesive tapes with excellent barrier function.

It is assumed that the surface character of the liner is impressed into the adhesive layer in such a way that the adhesive itself, shortly before adhesion on the substrate, is very smooth, and therefore optimized flow on the substrate is permitted, very substantially without air-channel inclusions. The liner surface therefore contributes very advantageously to the extent of the barrier effect. This is particularly advantageous in the case of adhesives having relatively low flowability, since in this case the surface structure impressed via the liner is very stable over time. This means that undesired flow is avoided over a prolonged period after the adhesive has been uncovered.

Adhesive tapes coated on one or both sides with adhesives are mostly wound up at the end of the production process to give a roll in the form of an Archimedean spiral. In order to prevent the adhesives in double-sided adhesive tapes from coming into contact with one another, or in order to prevent adhesion of the adhesive on the carrier in single-sided adhesive tapes, the adhesive tapes are covered, prior to winding, with a protective covering material (also termed release material), which is wound up together with the adhesive tape. Protective covering materials of this type are known to the person skilled in the art as liners or release liners. Liners are used not only for the protective covering of single- or double-sided adhesive tapes but also for the covering of adhesives having no carrier (transfer adhesive tape) and of adhesive tape sections (for example labels).

The term liner accordingly means a protective covering material that has an anti-adhesive (release) surface and that is directly applied to an adhesive for the temporary protection thereof, and that can generally be removed simply by peeling immediately prior to application of the adhesive.

Another function of these release liners is to prevent soiling of the adhesive prior to use. It is moreover possible to modify release liners by way of the nature and composition of the release materials in such a way as to permit (easy or difficult) unrolling of the adhesive tape by use of the desired force. In the case of adhesive tapes coated on both sides with adhesive, the release liners have the additional function of ensuring that the first side of the adhesive uncovered during unrolling is the correct side.

A liner is not a constituent of an adhesive tape, but instead is merely an aid to production or storage thereof, or an aid for further processing. A liner is moreover unlike an adhesive tape carrier in having no secure bonding to an adhesive layer; instead, the bond is merely temporary and not long lasting.

In the invention, the surface roughness of the release liner surface facing toward the pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 100 nm. It is preferable that the surface roughness of the release liner surface facing toward the pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 70 nm, particularly smaller than 30 nm. Liners with surfaces having this type of smoothness have proven to have excellent suitability for providing adhesive tapes with very low interface permeability to moisture and oxygen.

With the composite system of the invention it is possible to achieve WVTR (Ca test) values <1.5 g/(m²*d), preferably <1.0 g/(m²*d) for an adhesive with volume permeation WVTR (MOCON) <10 g/(m²*d).

The surface roughness of the release liner is determined in the invention as arithmetic mean Sₐ in accordance with ISO/FDIS 25178-2:2011 of the magnitudes of at least 10 000 profile height values for an area of at least 200 μm×200 μm. The standard ISO/FDIS 25178-2:2011 is based on use of an optical profilometer to measure the relevant surface. The surface profile is recorded here as interference pattern. From the resultant data it is possible, by using software usually associated with the profilometer, to calculate inter alia what is known as the “arithmetical mean height” Sₐ in accordance with the information provided in the standard. The term “magnitudes” is used here in its mathematical sense, i.e. the height values are used in the form of absolute value, and therefore as non-negative number, in the calculation of Sₐ.

Profilometers usually used are optical 3D microscopes or scanning atomic force microscopes, for example the “Contour GT® 3D white light interferometer optical microscope” from Bruker. These devices determine inter alia the height parameter z for a large number of measurement points in the x-y plane within an area usually located in the x-y plane. The resultant quantity of raw data is very large, and is therefore reduced by means of equipment software to parameters obtained by mathematical methods, these being parameters defined in the standard.

It is usual, and preferred in the invention, that release liners comprise at least respectively one carrier layer and one release layer. In accordance with the intended purpose of the liner, the release layer is preferably designed with release properties. This means that the adhesion of the release layer to the adhesive to be covered is lower than that of the adhesive to the application substrate intended in use thereof, and where appropriate to the carrier material associated with the adhesive.

The material of the release layer is preferably selected from the group comprising silicones, fluorinated silicones, silicone copolymers, waxes, carbamates, fluoropolymers, and polyolefins, and mixtures of two or more of the substances mentioned. It is particularly preferable that the material of the release layer is selected from silicones and polyolefins.

The design of the system forming the release layer is preferably such that there is hardly any diffusion of release substances into the adhesive. Analysis can sometimes still detect substances from the release coating, but these are attributable to mechanical abrasion. It is preferable that the release layer has almost no vapor pressure at room temperature.

It is particularly preferable that the release layer consists of a silicone system. Production of these silicone systems preferably uses crosslinkable silicone systems. Among these are mixtures of crosslinking catalysts and what are known as thermally curable condensation- or addition-crosslinking polysiloxanes. In the case of condensation-crosslinking silicone systems, tin compounds such as dibutyltin diacetate are often present as crosslinking catalysts in the composition.

Silicone-based release agents based on addition-crosslinking systems can be cured via hydrosilylation. These release agents usually comprise the following constituents:
an alkenylated polydiorganosiloxane (in particular linear polymers having terminal alkenyl groups),
a polyorganohydrosiloxane crosslinking agent, and
a hydrosilylation catalyst.

Examples of catalysts widely used for addition-crosslinking silicone systems (hydrosilylation catalysts) are platinum and platinum compounds, for example Karstedt's catalyst (a Pt(0) complex).

Thermally curing release coatings are therefore often multicomponent systems, which typically consist of the following components:
a) a linear or branched dimethylpolysiloxane which consists of about 80 to 200 dimethylpolysiloxane units and has terminal vinyldimethylsiloxy units at the chain ends. Typical representatives are by way of example solvent-free, addition-crosslinking silicone oils having terminal vinyl groups such as Dehesive® 921 or 610, both obtainable commercially from Wacker Chemie GmbH;
b) a linear or branched crosslinking agent which is usually composed of methylhydrosiloxy and dimethylsiloxy units, where the chain ends are terminated either by trimethylsiloxy groups or by dimethylhydrosiloxy groups. Typical representatives of this class of product are by way of example hydropolysiloxanes having high content of reactive Si—H, for example the crosslinking agents V24, V90, or V06, which are obtainable commercially from Wacker Chemie GmbH;
c) an MQ silicone resin which also has vinyldimethylsiloxy units as M unit alongside the trimethylsiloxy units usually used. Typical representatives of this group are by way of example the controlled release additive CRA® 17 or CRA® 42, obtainable commercially from Wacker Chemie GmbH;
d) a silicone-soluble platinum catalyst, for example a divinyltetramethyldisiloxane-platinum complex which is usually termed Karstedt's complex and which is obtainable commercially by way of example as catalyst OL from Wacker Chemie GmbH.

It is moreover also possible to use photoactive catalysts, known as photoinitiators, in combination with UV-curable cationically crosslinking epoxy- and/or vinyl-ether based siloxanes or with UV-curable siloxanes that crosslink by a free-radical route, for example acrylate-modified siloxanes. Equally, it is possible to use electron-beam-curable silicone acrylates. Appropriate systems can also comprise other additions such as stabilizers or leveling aids depending on the intended use.

Silicone-containing systems can be purchased by way of example from Dow Corning, Wacker, or Rohm & Haas.

Mention may be made by way of example of “Dehesive® 914”, which comprises a vinylpolydimethylsiloxane, the crosslinking agent “Crosslinker V24”, which comprises a methylhydropolysiloxane, and the catalyst “Catalyst OI” which comprises a platinum catalyst in polydimethylsiloxane. This system is obtainable from Wacker Chemie GmbH. Another product that can be used is by way of example the addition-crosslinking silicone release system marketed as “Dehesive® 940A” by Wacker Chemie, with an associated catalyst system, which is applied in the uncrosslinked state and then subsequently crosslinked after application.

Among the silicones mentioned, it is the addition-crosslinking silicones that have the greatest economic importance. However, an undesired property of these systems is their susceptibility to catalyst poisons, for example heavy metal compounds, sulfur compounds, and nitrogen compounds (cf. in this connection “Chemische Technik, Prozesse and Produkte” [Chemical technology, processes, and products] by R. Dittmeyer et al., volume 5, 5^{th} edition, Wiley-VCH, Weinheim, Germany, 2005, chapter 6-5.3.2, page 1142). As a general rule, electron donors can be regarded as platinum poisons (A. Colas, Silicone Chemistry Overview, Technical Paper, Dow Corning). Accordingly, phosphorus compounds such as phosphines and phosphites also have to be regarded as platinum poisons. Catalyst poisons stop, or greatly restrict the extent of, the crosslinking reaction between the various constituents of a silicone release coating. Catalyst poisons, in particular platinum poisons, are therefore strictly excluded during the production of antiadhesive silicone coatings.

Particular embodiments of the silicone systems are polysiloxane block copolymers, for example with a urea block, such as those marketed as “Geniomer” by Wacker, or release systems made of fluorosilicones, these being used in particular for adhesive tapes with silicone adhesives.

Polyolefinic release layers can consist of thermoplastic, non-elastic or else elastic materials. By way of example, release layers of this type can be based on polyethylene. Polyethylenes in the entire achievable density range of about 0.86 g/cm³ to 1 g/cm³ can be used here. For certain applications it is preferable to use low-density polyethylenes because they often provide lower release forces.

Release layers with elastic properties can equally consist of olefin-containing elastomers. Examples comprise not only random copolymers but also block copolymers. Among the block copolymers, mention may be made by way of example of ethylene-propylene rubbers, butyl rubber, polyisobutylene, ethylene block copolymers, and also partially and fully hydrogenated styrene-diene block copolymers, for example styrene-ethylene/butylene block copolymers and styrene-ethylene/propylene block copolymers.

Suitable release layers can moreover also be provided by acrylate copolymers. Preferred embodiments of this variant are acrylate polymers with a static glass transition temperature (midpoint TG determined by way of differential calorimetry) below room temperature. These are typically crosslinked polymers. The crosslinking here can be chemical or physical in nature, as is by way of example the case in block copolymers.

Carrier material used for the liner can in particular be foils. Foils can be polymer foils, metal foils, composite foils comprising metal foils, or foils having a metal layer obtained by sputtering or vapor deposition. Preference is given here to dimensionally stable polymer foils. The liner therefore preferably comprises at least one carrier layer which comprises at least 80% by weight, based on the total weight of the carrier layer, of polyester, in particular polyethylene terephthalate, for example biaxially oriented polyethylene terephthalate, or of polyolefins, in particular polybutene, cycloolefin copolymers, polymethylpentene, polypropylene, or polyethylene, for example monoaxially oriented polypropylene biaxially oriented polypropylene, or biaxially oriented polyethylene. It is particularly preferable that the release liner comprises at least one carrier layer which comprises at least 80% by weight, based on the total weight of the carrier layer, of polyolefin. It is very particularly preferable that the liner comprises at least one carrier layer which comprises at least 80%, by weight based on the total weight of the carrier layer, of polypropylene, in particular biaxially oriented polypropylene (BOPP). In particular, the liner comprises at least one carrier layer which consists of polypropylene, for example of biaxially oriented polypropylene. BOPP-based liners exhibit, very advantageously, extremely little tendency toward moisture absorption.

In principle it is possible to use not only the carrier layer materials listed above but also others, even if they do not initially have the smoothness required in the invention. This can by way of example be achieved via the application of the release layer, e.g. by what is known as the “smoothing bar method” (see by way of example section “Surface Engineering” in B. A. MacDonald et al., “Flexible Flat Panel Displays”, C. P. Crawford (ed.), 2005, Wiley, Hoboken).

The material of the release layer and the material of the carrier layer do not have to be homogeneous materials, but instead can also consist of mixtures of a plurality of materials: in order to optimize properties and/or processing, the materials can respectively have been blended with one or more additives such as resins, waxes, plasticizers, fillers, pigments, UV absorbers, light stabilizers, aging inhibitors, crosslinking agents, crosslinking promoters, antifoams, degassing agents, wetting agents, dispersing agents, rheology additives, or elastomers.

In one preferred embodiment, the release liner comprises at least one carrier layer and at least one barrier layer. The expression “barrier layer” means a barrier layer in relation to one or more specific permeates, in particular in relation to water vapor and oxygen. It is equally preferable in the invention that the liner comprises at least one carrier layer and said carrier layer has a barrier function in relation to one or more specific permeates.

The barrier layer can consist of organic or inorganic materials. It is preferable that the barrier layer is composed of at least one polymer foil selected from the group consisting of PUR, PP, PET, PVC, PVDC, PEN (polyethylene 2,6-naphthalate), PAN (polyacrylonitriles), EVOH (ethylene-vinyl alcohol copolymers), polyamides, nylon-6, poly(ε-caprolactam), and in particular polyacrylates (PA), and also nanocomposites based on the above polymers.

Nanocomposites are phyllosilicate-filled polymer. The phyllosilicate particles have a lamellar structure, similar to that of talc powder. However, the particle size is considerably smaller (nanometer range) than that of talc powder. During the extrusion process, these particles become oriented, and form a layer structure. The particles themselves are, like glass, completely impermeable to gases. Passage of the gases through the foil is inhibited, and this presumably gives the improved barrier effect. The layer structure forms a type of labyrinth through which the gases and odors have to pass. Because of the small particle size, there is hardly any impairment of the optical properties of the foil.

It is likewise preferable to use polyester and polypropylene as polymer foil. Polyester foils have good barrier properties. Foils of this type moreover feature good resistance to temperature changes and relatively high mechanical stability.

The thickness of a polymer-based barrier layer is preferably from 0.5 to 50 μm.

Inorganic barrier layers having particularly good suitability are metallic layers which are deposited in vacuo (for example by means of evaporation processes, CVD, PVD, PECVD, or sputtering) or at atmospheric pressure (for example by means of atmospheric plasma, reactive corona discharge, or flame pyrolysis), these in essence being based on metals and in particular on metal compounds such as metal oxides, metal nitrides, or metal hydronitrides, for example oxides or nitrides of silicon, of boron, of aluminum, of zirconium, of hafnium, or of tellurium, or on indium tin oxide (ITO). Layers of the abovementioned types doped with other elements are equally suitable. Other barrier layers having very good suitability are metal foils.

The thickness of the metallic layer is preferably from 5 nm to 100 μm, in particular from 15 nm to 50 μm.

The application of the metallic layer to the carrier layer is achieved by way of example via vapor deposition, i.e. by using thermal evaporation in vacuo (by an electrical method using electron beams, via cathodic sputtering or wire explosion, optionally with the aid of laser beams) to produce a coating on the polymer foil. The thickness of the metallic layer is then preferably from 5 nm to 100 nm, with preference from 10 nm to 30 nm.

The metallic layer can also consist of a rolled metal foil. In this case the thickness of the metallic layer is preferably from 5 μm to 100 μm, with preference from 10 μm to 30 μm.

The metallic layer preferably comprises at least 80% by weight, based on the total weight of the metallic layer, of silver, copper, gold, platinum, aluminum and aluminum compounds, tin, nichrome, NIROSTA, titanium, silicon dioxides, metal oxides such as cadmium oxides, tin oxides, zinc oxides, magnesium oxides.

In one specific embodiment, the release liner comprises at least one carrier layer and at least one barrier layer in relation to one or more specific permeates, where the barrier layer and the carrier layer are present as layers in direct succession. A particularly suitable process that may be mentioned for the application of an inorganic barrier layer is high power impulse magnetron sputtering or atomic layer deposition, which can realize particularly impermeable layers while subjecting the carrier layer to little thermal stress. It is preferable that a permeation barrier of the carrier layer with barrier function, or of the composite made of carrier layer and barrier layer, in relation to water vapor (WVTR) is <1 g/(m²*d), and/or in relation to oxygen (OTR) is <1 cm³/(m²*d*bar), particularly <0.1 g/(m²*d) and, respectively, <0.1 cm³/(m²*d*bar), where the value is based on the respective carrier layer thickness used in the liner, i.e. is not standardized to any specific thickness. The WVTR here is measured at 38° C. and 90% relative humidity in accordance with ASTM F1249, and the OTR here is measured at 23° C. and 50% relative humidity in accordance with DIN 53380, part 3.

It is particularly preferable that the release liner comprises at least one carrier layer and at least one barrier layer, and that the barrier layer comprises at least 80% by weight, based on the total weight of the barrier layer, of aluminum. A barrier layer of this type is in particular a vapor-deposited aluminum layer or an aluminum foil applied by lamination.

It is preferable that the liner has a multilayer structure, comprising at least one carrier layer, at least one barrier layer, and at least one release layer. It is preferable that the layers here are present in the following sequence, toward the adhesive to be covered: carrier layer, barrier layer, release layer. However, it is equally possible in the invention that the abovementioned sequence is as follows: barrier layer, carrier layer, release layer. The anchoring of the individual layers into one another can be assisted via physical pretreatment of the layer surfaces that come into contact with one another. Equally, the individual layers can be bonded to one another via a lamination adhesive or a primer. Particular lamination adhesives that can be used are pressure-sensitive adhesives based on synthetic rubbers and/or on polyacrylates, or are radiation-curing coatings or hot- or cold-sealable layers, or else are chemically hardening two-component liquid adhesives.

The release liner can moreover comprise, in one or more layers, what are known as getter materials or scavenger materials. The expression “getter material” or “scavenger” material means a material which can, in particular via a sorption process, selectively absorb at least one substance capable of permeation. The term “sorbent” or “sorption agent” could therefore also be used for the getter material.

The expression “substance capable of permeation” means a substance which is gaseous or liquid, or else where appropriate solid, and which can penetrate into the adhesive to be protected and can then permeate through said adhesive. Substances of this type are also termed “permeates”. The permeates can derive from the adhesive itself or from the environment, and also by way of example from the carrier material of an adhesive tape coated with the adhesive. Substances derived from the adhesive or from the adhesive tape itself are often low-molecular-weight organic compounds such as solvent residues, residual monomers, oils, resin components, plasticizers, and also water. Substances deriving from the environment are often water, volatile organic compounds (VOCs), low-molecular-weight hydrocarbons, and oxygen. The following substances in particular are regarded as “substances capable of permeation”:

Acetonitrile, 1-butanol, chlorobenzene, chloroform (trichloromethane), cyclohexane, diethyl ether, 1,4-dioxane, glacial acetic acid (acetic acid), acetic anhydride, ethyl acetate, n-butyl acetate, tert-butyl acetate, ethanol, methanol, n-hexane, n-heptane, 3-hexanone, 2-propanol (isopropanol), 3-methyl-1-butanol (isoamyl alcohol), methylene chloride (dichloromethane), methyl ethyl ketone (butanone), methylisobutyl ketone, nitromethane (nitrocarbol), n-pentane, 2-pentanone, 3-pentanone, petroleum ether, gasoline, propanol, pyridine (azine), tert-butyl methyl ether, tetrachloroethene (perchloroethene), tetrahydrofuran, toluene, trichloroethane, triethylamine, xylene, oxygen, methane, ethane, propane, propene, butane, butene, carbon dioxide, ozone, sulfur dioxide, water. It is preferable that the getter material is at least capable of the sorption of water.

The getter material(s) can be present as disperse phase in at least one of the layers of the liner, or as autonomous layer in the liner.

Particular examples of suitable getter or scavenger materials present in disperse form are: salts such as cobalt chloride, calcium chloride, calcium bromide, lithium chloride, lithium bromide, magnesium chloride, barium perchlorate, magnesium perchlorate, zinc chloride, zinc bromide, aluminum sulfate, calcium sulfate, copper sulfate, barium sulfate, magnesium sulfate, lithium sulfate, sodium sulfate, cobalt sulfate, titanium sulfate, sodium dithionite, sodium carbonate, sodium sulfate, potassium disulfite, potassium carbonate, magnesium carbonate; phyllosilicates such as montmorillonite and bentonite; metal oxides such as barium oxide, calcium oxide, iron oxide, magnesium oxide, sodium oxide, potassium oxide, strontium oxide, aluminum oxide (activated alumina) and titanium dioxide; and also carbon nanotubes, activated charcoal, phosphorus pentoxide, and silanes; readily oxidizable metals, for example iron, calcium, sodium, and magnesium;

metal hydrides, for example calcium hydride, barium hydride, strontium hydride, sodium hydride, and lithium aluminum hydride; hydroxides, for example potassium hydroxide and sodium hydroxide; metal complexes, for example aluminum acetylacetonate; and also silicas, for example silica gel; kieselguhr; zeolites; and moreover organic absorbers, for example polyolefin copolymers, polyamide copolymers, PET copolyesters, anhydrides of mono- and polybasic carboxylic acids, for example acetic anhydride, propionic anhydride, butyric anhydride or methyltetrahydrophthalic anhydride, or other absorbers which are based on hybrid polymers, these mostly being used in combination with catalysts, for example cobalt; other organic absorbers, for example weakly crosslinked polyacrylic acid, polyvinyl alcohol, ascorbates, glucose, gallic acid, or unsaturated fats and oils. Other materials advantageously used, in particular for binding of oxygen, are organometallic oxidation additives based on chelate-forming amines and transition metal complexes, in particular in conjunction with oxidizable substrate materials. It is also possible in the invention to use mixtures of two or more getter materials.

Materials suitable for autonomous getter layers are in particular lithium, beryllium, boron, sodium, magnesium, silicon, potassium, calcium, manganese, iron, nickel, zinc, gallium, germanium, cadmium, indium, cesium, barium, boron oxide, calcium oxide, chromium oxide, manganese oxide, iron oxide, copper oxide, silver oxide, indium oxide, barium oxide, lead oxide, phosphorus oxide, sodium hydroxide, potassium hydroxide, metal salts, metal hydrides, anhydrides of mono- and polybasic carboxylic acids, sodium dithionite, carbohydrazide, ascorbates, gallic acid, zeolites, carbon nanotubes, activated charcoal, and carbodiimides, and also mixtures of two or more of the above substances.

In one preferred embodiment, the release liner is designed to block UV. This means that the light transmittance through the release liner in the wavelength range from 190 to 400 nm is less than 5%, preferably less than 1%. It is therefore preferable that the release liner comprises UV absorbers, for example Tinuvin products from BASF, and/or color pigments, for example carbon black and/or titanium dioxide. Additives of this type can be present in the carrier layer and/or in the release layer of the liner. There can moreover also be UV-blocking layers laminated to the reverse side of the release liner or a UV-blocking print or coating applied on the reverse side of the liner or between carrier layer and release layer. A coating of this type sometimes also brings about smoothing of the carrier layer surface, e.g. via use of a smoothing bar on a coating material.

The release liner preferably has low equilibrium moisture content, and after the liner has been kept at 23° C. and 50% relative humidity for 24 h, and then immediately sealed into an impermeable bag, and passed onward for immediate Karl Fischer determination its water content by the Karl Fischer method is less than 300 ppm, particularly preferably less than 150 ppm.

The composite system of the invention further comprises at least one adhesive tape which comprises at least one pressure-sensitive adhesive for direct application on a substrate. The pressure-sensitive adhesive is preferably an activatable pressure-sensitive adhesive.

The term pressure-sensitive adhesives is used for adhesives which, after setting, give a film that remains permanently tacky and adhesive in the dry state at room temperature. Even when relatively weak pressure is applied, pressure-sensitive adhesives can give a long lasting bond to the substrate, and after use they can in turn be peeled from the substrate to leave in essence no residue. The adhesives have adhesive properties enabling adhesive bonding, and cohesive properties that in turn enable peeling.

Any of the pressure-sensitive adhesives known to the person skilled in the art can be used in the invention, in particular those based on nonpolar (thermoplastic) elastomers. Preference is given to pressure-sensitive adhesives based on natural rubbers, on synthetic rubbers, on butyl rubbers, on isobutyl rubbers; on polyolefins, on fluoropolymers; on polybutadienes, on polyisoprenes; on styrene block copolymers, in particular those having an elastomer block made of unsaturated or hydrogenated polydiene blocks, for example polybutadiene, polyisoprene, and polyisobutylene, or else copolymers of these, or else other elastomer blocks familiar to the person skilled in the art.

For the purposes of the invention it is possible to use combinations and mixtures of a plurality of main polymers, or else adhesives to which adhesive resins, fillers, aging inhibitors, and crosslinking agents have been added, this being merely a non-restrictive example of a list of the additives.

Adhesive systems regarded as activatable pressure-sensitive adhesives are those where the final adhesive bond is achieved via introduction of energy, for example via actinic radiation or heat, in addition to the inherent pressure-sensitive-adhesive capability.

Heat-activated adhesives can in principle be classified into two categories: thermoplastic heat-activated adhesives (hot-melt adhesives) and reactive heat-activated adhesives (reactive adhesives). Also included are those adhesives that can be classified in both categories, namely reactive thermoplastic heat-activated adhesives (reactive hot-melt adhesives).

Thermoplastic adhesives are based on polymers which soften reversibly on heating and become solid again during cooling. Thermoplastic adhesives that have proven advantageous are in particular those based on polyolefins and on copolymers of polyolefins, or else on acid-modified derivatives of these, on ionomers, on thermoplastic polyurethanes, on polyamides, or else on polyesters and on copolymers of these, or else on block copolymers, for example styrene block copolymers.

In contrast to this, reactive heat-activated adhesives comprise reactive components. The latter constituents are also termed “reactive resins” in which heating induces a crosslinking process which, after completion of the crosslinking reaction, ensures a long lasting stable bond. It is preferable that adhesives of this type also comprise elastic components, for example synthetic nitrile rubbers or styrene block copolymers. Because elastic components of this type have high flow viscosity, they provide particularly high dimensional stability to the heat-activated adhesive, even under pressure.

Radiation-activated adhesives are likewise based on reactive components. The latter constituents can by way of example comprise polymers or reactive resins in which irradiation induces a crosslinking process, which ensures a long lasting stable bond after completion of the crosslinking reaction. It is preferable that adhesives of this type also comprise elastic components, as listed above.

It is preferable to use activatable adhesives based on epoxides, on oxetanes, on (meth)acrylates, or on modified styrene block copolymers.

The adhesive tape of the composite of the invention comprises at least one pressure-sensitive adhesive, preferably one activatable pressure-sensitive adhesive. The adhesive tape can also comprise further layers, for example one or more further adhesive layers, or a carrier material.

It is preferable that the adhesive tape comprises only one layer of an adhesive (transfer adhesive tape), since the structure is thus kept simple, and the number of possible permeates to be considered can be kept small because the number of different materials is relatively small.

The thickness of the adhesive tape can comprise all conventional thicknesses, i.e. for example from 3 μm up to 500 μm. Preference is given to a thickness of from 3 to 100 μm, since adhesion and handling properties obtained within this range are particularly advantageous. Particular preference is given to a thickness of from 3 to 30 μm, for example from 3 to 25 μm, since within this range the quantity of substances permeating through the adhesive joint in an encapsulation application can be kept small simply by virtue of the small cross-sectional area of the adhesive joint. However, the thinner an adhesive layer, the less capability it has to adapt to a surface. Particular preference is therefore given to a composite made of thin adhesive tape and of a liner with surface roughness of the invention, because it is thus possible to achieve optimized encapsulation of the usually smooth organoelectronic structures with little interface permeation.

The composite of the invention, made of adhesive tape and liner, is produced by coating or printing, onto the carrier of the adhesive tape or one side of the liner, the preferred pressure-sensitive adhesive of the adhesive tape, from solution or dispersion, or without dilution (an example being a melt), or by using coextrusion to produce the composite.

Alternatively, it is possible to form a composite by using lamination to transfer an adhesive layer or a liner. The adhesive layer(s) can be crosslinked by heat or high-energy radiation.

In order to optimize properties, the self-adhesive used can have been blended with one or more additives such as tackifiers (resins), plasticizers, fillers, pigments, UV absorbers, light stabilizers, aging inhibitors, crosslinking agents, crosslinking promoters, or elastomers.

The quantity of the adhesive layer is preferably from 3 to 500 g/m², with preference from 3 to 100 g/m², particularly preferably from 3 to 30 g/m², for example from 3 to 25 g/m², where the term “quantity” means the quantity after any water- or solvent-removal process that may be carried out.

The invention further provides a process for the production of a release liner which comprises at least one carrier layer, where the surface roughness of at least one release liner surface for application on a pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 100 nm, comprising use of a smoothing bar to apply at least one coating to the carrier layer. In respect of use of a smoothing bar, reference is made to B. A. MacDonald et al., “Flexible Flat Panel Displays”, C. P. Crawford (ed.), 2005, Wiley, Hoboken).

The invention further provides the use of a release liner comprising at least one side with surface roughness, determined as arithmetic mean Sₐ in accordance with ISO/FDIS 25178-2:2011 of the magnitudes of at least 10 000 profile height values for an area of at least 200 μm×200 μm, smaller than 100 nm, for providing adhesive tapes for the encapsulation of optoelectronic arrangements.

The invention further provides the use, for the encapsulation of optoelectronic arrangements, of an adhesive tape obtained via removal of the release liner from a composite system of the invention. The term “encapsulation” in the invention means any type of complete or partial covering of an article with the aim of protecting said article from exterior effects, in particular from substances detrimental to the intended use of the article.

### EXAMPLES

### Test Methods

Surface Roughness:

The surface roughness of the liners was determined by using a Contour GT® 3D white light interferometer optical microscope from Bruker. The method was based on ISO 25178-602. The device was operated in vertical scanning (VSI) mode. A 20× objective and a 1× field lens were used, giving twenty-fold magnification. The field of view was 317 μm×238 μm. Evaluation of the surface roughness Sₐ was based on this area. The raw data from the optically recorded height profile were used in accordance with ISO 25178-2 to obtain surface roughness as mean value of the 3D profile Sₐ. Sₐ is the arithmetic mean of the magnitudes of the height values z of all of the points measured in the x, y plane of the field of view. In each case, three measurements were made and the mean value of the individual measurements was stated in nm. The distance of the measurement points from one another was 0.5 μm in both x- and y-direction.

Transparency:

Transmittance was measured at wavelength 200 nm, 300 nm, and 400 nm in a UVIKON 923 UV/VIS double-beam spectrophotometer from Bio-Tek Kontron Instruments. The beam path without sample was used as reference. Transmittance was determined for the respective measurement wavelength in percent of incident luminous intensity, and an arithmetic mean was calculated.

Water Content (Karl Fischer):

Moisture content was determined by the Karl Fischer method in accordance with DIN EN ISO 15512B. A Karl Fischer coulometer 851 was used. In the Karl Fischer method iodine is produced from iodide by anodic oxidation. Iodine in turn reacts with any water present, and this is followed coulometrically. Oven temperature was 140° C., and carrier gas was nitrogen flowing at 50 ml/min. Merck CombiCoulomat fritless was used for the titration.

WVTR (Ca test):

A calcium test was used as a measure for determining the lifetime of an (opto)electronic structure. For this, a thin calcium layer measuring 10 mm×10 mm was deposited in vacuo onto a glass plate, and then stored under nitrogen. The thickness of the calcium layer was about 100 nm. The calcium layer was encapsulated by using an adhesive tape (23 mm×23 mm) with the adhesive to be tested with a 30 μm thin glass (Schott) as carrier material with WVTR (MOCON)=0 g/m²*d in accordance with ASTM F1249 and DIN 53380 part 3 and abovementioned conditions. The adhesive tape was applied with a margin of 6.5 mm beyond the calcium surface on all sides, where it adhered directly on the glass plate.

The test is based on the reaction of calcium with water vapor and oxygen as described by way of example by A. G. Erlat et al., in “47^{th} Annual Technical Conference Proceedings—Society of Vacuum Coaters”, 2004, pages 654-659, and by M. E. Gross et al. in “46^{th} Annual Technical Conference Proceedings—Society of Vacuum Coaters”, 2003, pages 89 to 92. The light transmittance of the calcium layer is monitored here, and increases via conversion into calcium hydroxide and calcium oxide. Lifetime end is defined as the time at which 85% of the transmittance of the structure without calcium layer is reached. Measurement conditions selected were 60° C. and 95% rel. humidity. Bubble-free adhesive bonding over the entire surface of the samples was achieved with a pressure-sensitive adhesive with layer thickness 50 μm.

WVTR (MOCON):

Volume permeability to water vapor WVTR (MOCON) was determined in accordance with DIN 53380 part 3 or ASTM F1249. For this, a layer thickness of 50 μm of the pressure-sensitive adhesive was applied to a permeable membrane. Water vapor transmission rate was determined by using Mocon OX-Tran 2/21 measurement equipment at 37.5° C. and 90% relative humidity.

### Example 1 (of the Invention)

Liner used was a silicone-coated PET liner with thickness 38 μm. Its surface roughness Sₐ was 55 nm.

The adhesive was composed of an elastomer, an adhesive resin, a reactive resin, and a photoinitiator. Elastomer used was polystyrene-polyisobutylene block copolymer from Kaneka with 20% styrene content in the entire polymer. Sibstar 62M (300 g) was used. Molar mass was 60 000 g/mol. The glass transition temperature of the polystyrene blocks was 100° C., and that of the polyisobutylene blocks was −60° C. Adhesive resin selected was Escorez 5300 (ring and ball 105° C., DACP=71, MMAP=72) from Exxon, a fully hydrogenated hydrocarbon resin (200 g). Reactive resin used was Uvacure 1500 from Dow, a cycloaliphatic diepoxide (500 g). The glass transition temperature of Uvacure 1500 was −53° C. These raw materials were incorporated into a mixture of toluene (300 g), acetone (150 g), and 60/95 SBP gasoline (550 g) to give a 50% solution.

A photoinitiator was the added to the solution. For this, 10 g of triarylsulfonium hexafluoroantimonate (purchased from Sigma Aldrich) were weighed out. The photoinitiator took the form of 50% solution in propylene carbonate. The photoinitiator had an absorption maximum in the range from 320 nm to 360 nm.

An applicator-bar process was used to coat the formulation from solution onto the siliconized PET liner; the formulation was dried for 15 min at 110° C., and covered with a second layer of the (same) PET liner. The mass applied per unit area was 50 g/m². The liners were removed from some of these samples, and the volume barrier WVTR (MOCON) of these was studied in the MOCON test. The value was 9 g/m²d.

Other samples were sealed into a glove box (water content and oxygen content in each case 1 ppm), the more easily releasable liner was removed, and the samples were conditioned uncovered for 3 days. This preconditioning was carried out in order to exclude the influence of any residual moisture in the adhesive on the subsequent Ca WVTR test. It is known that, because of direct contact, any moisture content in the adhesive layer leads to early-stage reaction with the calcium surface in the Ca WVTR test, and this can distort the water permeation results in the test. A rubber application roller was used for bubble-free lamination of the samples on a glass substrate with a vapor-deposited calcium layer. The second PET liner was then removed, and a layer of a thin glass was laminated onto the sample. UV light was then used to cure the sample through the glass covering. The curing process used an undoped mercury source with a dose of 80 mJ/cm².

The resultant samples were used to study interface permeation in a WVTR test (Ca test).

The lifetime test result from the WVTR test (Ca test) was 0.8 g/m²*d.

### Example 2 (of the Invention)

Liner selected was a BOPP foil with thickness 50 μm, provided with a UV-silicone-based release coating material. Its surface roughness Sₐ was 20 nm.

The adhesive from example 1 was used. An applicator-bar process was used to coat the formulation from solution onto the siliconized BOPP liner; the formulation was dried for 15 min at 110° C., and covered with a second layer of the (same) BOPP liner. The mass applied per unit area was 50 g/m². The liners were removed from some of these samples, and the volume barrier WVTR (MOCON) of these was studied in the MOCON test. The value was 9 g/mm²d.

Other samples were sealed into a glove box (for conditions see example 1), the more easily releasable liner was removed, and the samples were conditioned uncovered for 3 days. A rubber application roller was used for bubble-free lamination of the samples on a glass substrate with a vapor-deposited calcium layer. The second BOPP liner was then removed, and a layer of a thin glass was laminated onto the sample. UV light was then used to cure the sample through the glass covering (for conditions see example 1). The resultant samples were used to study interface permeation in a WVTR test (Ca test). The lifetime test result from the WVTR test (Ca test) was 0.6 g/m²*d.

### Example 3 (of the Invention)

Liner selected was an MOPP foil with thickness 50 μm provided with a UV-silicone-based release coating material. Its surface roughness Sₐ was 100 nm.

The adhesive from example 1 was used. An applicator-bar process was used to coat the formulation from solution onto the siliconized MOPP foil; the formulation was dried for 15 min at 110° C., and covered with a second layer of the (same) silconized MOPP foil. The mass applied per unit area was 50 g/m². The liners were removed from some of these samples, and the volume barrier WVTR (MOCON) of these was studied in the MOCON test. The value was 9 g/m²d.

Other samples were sealed into a glove box (for conditions see example 1), the more easily releasable liner was removed, and the samples were conditioned uncovered for 3 days. A rubber application roller was used for bubble-free lamination of the samples on a glass substrate with a vapor-deposited calcium layer. The second MOPP liner was then removed, and a layer of a thin glass was laminated onto the sample. UV light was then used to cure the sample through the glass covering (for conditions see example 1). The resultant samples were used to study interface permeation in a WVTR test (Ca test). The lifetime test result from the WVTR test (Ca test) was 1.3 g/m²*d.

### Example 4 (Comparison)

Liner selected was another MOPP foil with thickness 50 μm, provided with a UV-silicone-based release coating material. Its surface roughness Sₐ was 124 nm.

The adhesive from example 1 was used. An applicator-bar process was used to coat the formulation from solution onto the siliconized MOPP liner; the formulation was dried for 15 min at 110° C., and covered with a second layer of the (same) MOPP liner. The mass applied per unit area was 50 g/m². The liners were removed from some of these samples, and the volume barrier WVTR (MOCON) of these was studied in the MOCON test. The value was 9 g/m²d.

Other samples were sealed into a glove box (for conditions see example 1), the more easily releasable liner was removed, and the samples were conditioned uncovered for 3 days. A rubber application roller was used for bubble-free lamination of the samples on a glass substrate with a vapor-deposited calcium layer. The second MOPP liner was then removed, and a layer of a thin glass was laminated onto the sample. UV light was then used to cure the sample through the glass covering (for conditions see example 1). The resultant samples were used to study interface permeation in a WVTR test (Ca test). The lifetime test result from the WVTR test (Ca test) was 1.9 g/m²*d.

The same adhesive was used in each of the examples. A volume permeation test by way of the MOCON WVTR method confirmed that volume permeability to water vapor was constant even when liner types of different surface roughness were used. In contrast to the MOCON WVTR test, which indicates only the volume permeation properties of a material, the Ca WVTR test also reflects the interface permeation properties of a composite consisting of the adhesive and of a substrate to be adhesive-bonded. Since examples 1 to 4 have shown that volume permeability is identical, the differences in the Ca WVTR test can be attributed to differences in interface permeation. Comparison of examples 1 to 4 shows that a liner with the low surface roughness of the invention leads to a lower Ca WVTR value, and this can be attributed to reduced interface permeation.

1. A composite system for the encapsulation of electronic arrangements, the composite system comprising at least
a) an adhesive tape comprising at least one pressure-sensitive adhesive for direct application on a substrate; and
b) at least one release liner superposed directly on the pressure-sensitive adhesive, where a surface roughness of the release liner surface facing toward the pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 100 nm.

2. The composite system according to claim 1, wherein the surface roughness of the release liner surface superposed directly on the pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 70 nm.

3. The composite system according to claim 1, wherein an equilibrium moisture content of the release liner, determined by the Karl Fischer method, is less than 300 ppm.

4. The composite system according to claim 1, wherein the release liner comprises at least one carrier layer comprising at least 80% by weight, based on the total weight of the carrier layer, of polyester and/or polyolefin.

5. The composite system according to claim 1, wherein the release liner comprises at least one carrier layer comprising at least 80% by weight, based on the total weight of the carrier layer, of polyolefin.

6. The composite system according to claim 1, wherein the release liner comprises at least one carrier layer consisting of polypropylene.

7. The composite system according to claim 1, wherein the release liner comprises at least one carrier layer and at least one barrier layer.

8. The composite system according claim 7, wherein the barrier layer comprises at least 80% by weight, based on the total weight of the barrier layer, of aluminum.

9. The composite system according to claim 1, wherein a light transmittance through the release liner in the wavelength range from 190 to 400 nm is less than 5%.

10. A process comprising:
producing release liner which comprises at least one carrier layer, where a surface roughness of at least one release liner surface for application on a pressure-sensitive adhesive, determined as arithmetic mean Sₐ in accordance with ISO/FDIS 25178-2:2011 of the magnitudes of at least 10 000 profile height values for an area of at least 200 μm×200 μm, is smaller than 100 nm, and
applying at least one coating to the at least one carrier layer via a smoothing bar.

11. A method for encapsulation of an optoelectronic arrangements, the method comprising:
providing an adhesive tape having a release liner that comprises at least one side with surface roughness, determined as arithmetic mean Sₐ in accordance with ISO/FDIS 25178-2:2011 of the magnitudes of at least 10 000 profile height values for an area of at least 200 μm×200 μm, of smaller than 100 nm.

12. A method comprising:
encapsulating one or more optoelectronic arrangements with the adhesive tape obtained via removal of the release liner from the composite system according to claim 1.
